(19) United States
(12) Patent Application Publication
(10) Pub. No.: US 2026/0316806 A1
(43) Pub. Date: Oct. 15, 2026

(54) A METHOD FOR SECTIONING A CONDUIT NETWORK FOR MONITORING AND MAINTENANCE

(71) Applicant: FNV IP B.V., Nootdorp (NL)

(72) Inventors: Karim EL LAHAM, Nootdorp (NL); Neda SEPASIAN, Nootdorp (NL)

(73) Assignee: FNV IP B.V., Nootdorp (NL)

(21) Appl. No.: 19/485,883

(22) PCT Filed: Jun. 3, 2024
(86) PCT No.: PCT/EP2024/065154

§ 371 Date: Nov. 19, 2025

(30) Foreign Application Priority Data
Jun. 5, 2023 (NL) 2034990

(51) Int. Cl. B61L 27/53

(52) U.S. Cl. CPC B61L 27/53

(57) ABSTRACT

The disclosure provides a method for sectioning a conduit network for monitoring/maintenance. The method comprises receiving network context information for a conduit network, assigning network context variable(s) to each of a plurality of conduit locations based on the received network context information, wherein the network context variable(s) is associated with a predicted conduit condition variation; and sectioning a plan of the conduit network into a plurality of conduit lengths by defining a first section based on assigned network context variable(s) for conduit locations along a first conduit length meeting a first criteria; and defining a second section based on one or more assigned network context variables for locations along a second conduit length meeting a second criteria. Associated systems are also disclosed. Unlocking insights from Geo-Data, the present invention further relates to improvements in sustainability and environmental developments: together we create a safe and liveable world.

### TECHNICAL FIELD

The disclosure relates generally to methods for sectioning a conduit network for monitoring and/or maintenance. The disclosure further provides methods for predicting conduit condition variation associated with one or more network context variables. The methods described herein may be computer-implemented methods. The disclosure also provides systems configured to implement the methods. Unlocking insights from Geo-Data, the present invention further relates to improvements in sustainability and environmental developments: together we create a safe and liveable world.

### BACKGROUND

Infrastructure networks (such as inter-city or urban railways, high-speed rail, monorails, metro or underground rail systems, pipelines, road networks, utilities infrastructure, bridges, tunnels, viaducts, waterway boundaries such as canal walls and riverbanks, quays, etc.) are valuable physical assets that require ongoing monitoring and maintenance across the network. One of the challenges faced by asset owners, managers and users is the need to maintain the infrastructure network, without (or with minimal) disruption to services. Network monitoring that allows for predictive maintenance can be key to minimising interruption of service.

One example of an environment in which network monitoring and maintenance is key is rail-based infrastructure, such as traditional railways. These railways are generally constructed of a pair of horizontal rails, resting upon a plurality of sleepers, arranged perpendicular to the direction in which the rails extend. The sleepers rest upon a layer of ballast, which itself sits above a base layer, which is often a layer of compacted material or a natural substrate. The track ideally has a flat and smooth vertical profile, with minimal location variations in track height at the rail head (the top portion of the rail). Ideally, the track further has a constant spacing between the two rails, a minimal local deviation (horizontal and/or vertical) of one or both rails. Although monorail networks generally rely on a single carriage-supporting rail, the rail that forms a monorail track ideally has a flat and smooth vertical profile, with minimal local variations in track height, and minimal horizontal and vertical deviations of the rails.

Monitoring the condition of conduit networks with a view to reducing or avoiding disruptive or unnecessary monitoring and/or maintenance may lead to more sustainable network operation since unnecessary resource consumption (e.g., construction materials) may be avoided. Moreover, in low- or reduced-carbon transport networks, reducing disruptive maintenance has the potential to increase the total capacity of the network, reducing reliance of more carbon intensive transport options.

There is therefore a need for improved systems and methods for monitoring infrastructure network condition.

### SUMMARY

According to a first aspect of the disclosure, there is provided a method for sectioning a conduit network for monitoring and/or maintenance. The method comprises receiving information representative of network context for a conduit network, assigning one or more network context variables to each of a plurality of conduit locations based on the received network context information, wherein the one or more network context variables is associated with a predicted conduit condition variation; and sectioning a plan of the conduit network into a plurality of conduit lengths. The step of sectioning comprises: defining a first section based on one or more assigned network context variables for a first plurality of conduit locations along a first conduit length meeting a first criteria; and defining a second section based on one or more assigned network context variables for a second plurality of conduit locations along a second conduit length meeting a second criteria.

The sectioning can further comprise defining a third section, wherein the third section is based on one or more assigned network context variables for a third plurality of conduit locations along a third conduit length meeting a third criteria. A fourth section may also be defined, the fourth section being based on one or more assigned network context variables for a fourth plurality of conduit locations along a fourth length meeting a fourth criteria, etc. In general, the sectioning can comprise defining n sections, wherein the nth section is based on one or more assigned network context variables for an nth plurality of conduit locations along an nth length meeting an nth criteria.

Each location of the plurality of locations may be assigned a single network context variable.

Each location of the plurality of locations may be assigned multiple network context variables.

In some examples, some locations may be assigned one network context variable, whilst others are assigned multiple network context variables.

The plurality of locations can comprise a plurality of locations along the length of the conduit, optionally spaced at a predefined interstitial distance in a longitudinal direction. The locations can be defined within the frame of reference of the conduit network (e.g., at locations from a predefined start point within the conduit network) or the locations may be defined in a global frame of reference, e.g. informed by GPS location coordinates.

One or more of the assigned network context variables may be qualitative.

One or more of the assigned network context variables may be quantitative. Where multiple network context variables are assigned, some may be qualitative and some may be quantitative.

The criteria for at least one of the defined sections may comprise one or more common network context variables being assigned to the plurality of conduit locations for the section. For example, at least one of the network context variables assigned to each location in the section being the same.

The criteria for at least one of the defined sections can be a network context variable associated with each of the conduit locations for the section being within a target group. For example, at least one of the network context variables assigned to each location in the section being from a selected group of network context variables.

The one or more network context variables can comprise a value indicative of predicted conduit condition variation. For example, the network context variable can comprise a value that indicates how much a section of conduit is likely to degrade over a predefined interval. The interval may be time, it may be traffic volume, or it may be another relevant interval for the conduit network.

The criteria for at least one of the defined sections can comprise one or more network context variables for each of the conduit locations for the section having a value within a target range. The target range is optionally above or below a threshold value.

The criteria for at least one of the defined sections can comprise a predicted maximum conduit condition variation for the section being within a target range. For example, a peak predicted conduit condition variation being outside a target range can be a criteria for defining a section.

The criteria for at least one of the defined sections can comprise a predicted total conduit condition variation for each section being within a target range. For example, a total predicted conduit condition variation may be based on a combination of all network context variables indicating conduit condition variation.

In any of the examples described herein, multiple network context variables can be assigned to each of the plurality of locations. In such cases, the method can further comprise assigning a weighting to each network context variable associated with conduit condition variation.

The method can further comprise identifying a transition based on the assigned network context variables and defining a transition zone extending in at least one direction from the identified transition. A transition may be identified as a change in the context information between two regions or a boundary between two network contexts. For example, a change from a first soil type to a second soil type may be identified as a transition.

The transition zone can be defined as a length of conduit before and/or after the transition. The length may be defined in meters. The transition zone before a transition and the transition zone after a transition may be different.

The length and/or location of the transition zone can be based on a travel direction for the conduit.

The length of transition zone can be based on a conduit speed rating.

Examples of network context variables according to the first aspect of the disclosure include an environmental condition, a soil type, a substrate type, a construction characteristic, a connection type, a structure type, a conduit material, and a geometric parameter of the conduit, a speed and/or flow rating for the conduit, a traffic rating for the conduit, historical conduit condition variation, a predicted conduit condition variation and a transition zone.

Examples of conduits forming conduit networks within the context of the present disclosure include: a railway, a pipeline, a tunnel, a bridge, a viaduct, a waterway boundary, a quay, a road, a conductive conduit, such as an electricity distribution network, and a communications conduit, for example a wired data transmission network providing, e.g., internet connectivity.

The methods described above can further comprise determining a schedule for monitoring and/or maintenance for the defined sections of conduit; and optionally, carrying out scheduled monitoring and/or maintenance according to the schedule.

In a second aspect of the disclosure, there is provided a method for predicting conduit condition variation associated with one or more network context variables in a conduit network. The method comprises receiving historical data indicative of conduit condition variation for a plurality of locations in a conduit network comprising at least one length of conduit, receiving information representative of one or more network context variables for the plurality of locations in the conduit network, and correlating historical conduit condition variation with one or more network context variables to determine a predicted conduit condition variation value for each network context variable.

The historical data indicative of conduit condition can comprise conduit geometry information, optionally, wherein the conduit network is a rail network and wherein the historical data indicative of conduit condition comprises relative and/or absolute conduit geometry data.

Each location of the plurality of locations may be assigned a single network context variable. Each location of the plurality of locations may be assigned multiple network context variables. In some examples, some locations are assigned one network context variable, whilst others are assigned multiple network context variables.

The plurality of locations can comprise a plurality of locations along the length of the conduit, optionally spaced at a predefined interstitial distance in a longitudinal direction. The locations can be defined within the frame of reference of the conduit network (e.g., at locations from a predefined start point within the conduit network) or the locations may be defined in a global frame of reference, e.g. informed by GPS location coordinates.

One or more of the assigned network context variables may be qualitative.

One or more of the assigned network context variables may be quantitative. Where multiple network context variables are assigned, some may be qualitative and some may be quantitative.

The method can further comprise identifying a transition based on the assigned network context variables and defining a transition zone extending in at least one direction from the identified transition. A transition may be identified as a change in the context information between two regions or a boundary between two network contexts. For example, a change from a first soil type to a second soil type may be identified as a transition.

The transition zone can be defined as a length of conduit before and/or after the transition. The length may be defined in meters. The transition zone before a transition and the transition zone after a transition may be different.

The length and/or location of the transition zone can be based on a travel direction for the conduit.

The length of transition zone can be based on a conduit speed rating.

Multiple network context variables can be assigned to each of the plurality of locations. In such examples, the method can further comprise assigning or determining a weighting to each network context variable associated with conduit condition variation. Determining a weighting may comprise analysing the relative importance of a known network context variable on conduit condition variation compared to other network context variables. For example, a network context variable known to be strongly correlated with conduit condition variation may be assigned a higher waiting than a network context variable know to be weakly correlated with conduit condition variation.

Examples of network context variables according to second aspect of the disclosure include: an environmental condition, a soil type, a substrate type, a construction characteristic, a connection type, a structure type, a conduit material and a geometric parameter of the conduit, a speed and/or flow rating for the conduit, a traffic rating for the conduit, historical conduit condition variation, a predicted conduit condition variation, a transition zone.

Examples of conduits forming conduit networks within the context of the present disclosure include: a railway, a pipeline, a tunnel, a bridge, a viaduct, a waterway boundary, a quay, a road, a conductive conduit, such as an electricity distribution network, and a communications conduit, for example a wired data transmission network providing, e.g., internet connectivity.

In a third aspect of the disclosure, there is provided a method comprising the steps of the method according to the second aspect of the disclosure, followed by the steps of the method according to the first aspect of the disclosure. In such a method, any of the optional features of the method according to the first aspect and/or the optional features of the method according to the second aspect may be implemented.

In a fourth aspect of the disclosure, there is provided a computer system comprising one or more processors configured to carry out the steps of any of the methods described above.

In a fifth aspect of the disclosure, there is provided a computer readable medium comprising instructions that, when executed by one or more data processes apparatus, cause the one or more processing apparatus to perform operations comprising the steps of any of the methods described above.

Examples of the invention, provided across aspects of the disclosure may be combined.

### BRIEF DESCRIPTION OF THE DRAWINGS

The disclosure will be further described with reference to illustrative embodiments and in connection with the following drawings, in which:

FIG. 1 shows, in schematic form, a conduit network within an environment;

FIG. 2A shows, in schematic form, a portion of conduit from the network shown in FIG. 1, sectioned for monitoring and/or maintenance according to a fixed sectioning method;

FIG. 2B shows, in schematic form, the portion of the conduit network from FIG. 2A, sectioned for monitoring and/or maintenance according to an embodiment of the disclosure;

FIG. 3 shows a flowchart representing a method according to an embodiment of the disclosure;

FIG. 4 shows a flowchart representing a method according to an embodiment of the disclosure;

FIG. 5 shows a section of railway track;

FIG. 6 shows a stretch of railway track sectioned according to a fixed sectioning method;

FIGS. 7A to 7F illustrate the measured track geometry variation for the sections shown in FIG. 6;

FIG. 8 shows the stretch of railway track from FIG. 6 sectioned according to an embodiment of the disclosure;

FIGS. 9A to 9F illustrate the measured track geometry variation for the sections shown in FIG. 8;

FIG. 10 shows a matrix illustrating correlation between a plurality of network context variables and track condition;

FIG. 11 shows, in schematic form, the components of a system suitable for use in connection with embodiments of the present disclosure.

### DETAILED DESCRIPTION OF THE DRAWINGS

The following detailed description is merely exemplary in nature and is not intended to limit the application and its uses. Furthermore, there is no intention to be bound by expressed or implied theory presented in the preceding technical field, background, brief summary or the following detailed description. As used herein, the term ‘module’ refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realised by any number of hardware, software, and/or firmware components configured to perform the specified functions. For example, embodiments of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practised in conjunction with any number of systems, and that the systems described herein are merely exemplary embodiments of the present disclosure.

For the sake of brevity, conventional techniques compared to signal processing, data transmission, signalling, control and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connection may be present in an embodiment of the present disclosure.

Systems and methods described herein relate to sectioning a conduit network plan for monitoring and/or maintenance of the conduit network. The disclosure also relates to systems and methods for predicting conduit condition variation in a conduit network based on network context information for the conduit network.

As will be appreciated from the following disclosure, the systems and methods described herein may allow for more efficient and effective monitoring and maintenance of conduit networks by identifying portions of the network that may require frequency monitoring and/or maintenance.

Embodiments of the disclosure are generally applicable to conduit networks.

As used herein, a conduit network comprises one or more lengths of conduit configured for transport of traffic, goods, resources, and/or data. Examples of conduit networks include railway networks, road networks, pipelines for transport of utilities (such as water or gas), electrical distribution networks, waterways, tunnel networks, wired data transmission networks, and the like. The network can comprise a single length of conduit. However, a network of conduits will more usually comprise a plurality of conduits, optionally comprising one or more junctions connecting the lengths of conduit to form a branched network.

The present disclosure makes use of network context information to determine and predict maintenance and/or monitoring requirements for conduit networks and to predict conduit condition variation across the network.

Network context information can comprise network context variables that include structural information related to one or more lengths of conduit within the network, directional information for one or more lengths of conduit (e.g., which direction traffic or resources flow through a conduit), environmental information for one or more lengths of conduit within the network (e.g., geological information, soil type, built environment structures, ambient conditions, etc.), transport volume information (e.g., tonnage or flow volume through a conduit) and/or regulatory information for one or more lengths of conduit within the network (e.g., a speed or flow restriction). Network context information may be qualitative or quantitative, as will be apparent from the following description.

Network context information can take the form of one or more network context variables, which may be associated with a predicted conduit condition variation. Conduit condition variation is an indicator of track condition, which may be represented, for example, by a measurable key performance indicator, such as relative or absolute conduit geometry.

The network context variables may be associated directly with discrete conduit locations along the conduits that make up the conduit network. Alternatively, the network context variables may be associated with regions in the conduit network and assigned to conduit locations. In either case, it will be appreciated that network context variables may be assigned to a plurality of locations along the conduits within the conduit network.

Each conduit location may be assigned a plurality of network context variables. Alternatively, each conduit location may be assigned a single network context variable.

In the following detailed description, systems and methods according to the disclosure will first be explained in the context of a general conduit network. A more detailed example will then be set forth in the context of a railway network. As will be appreciated from the following description, the disclosure is not limited to the illustrative examples set forth in the following description. Exemplary details described in the context of a railway network may be applied to other conduit networks. Similarly, details described in connection with a general conduit network may be implemented in connection with the embodiments described herein in the context of a railway network.

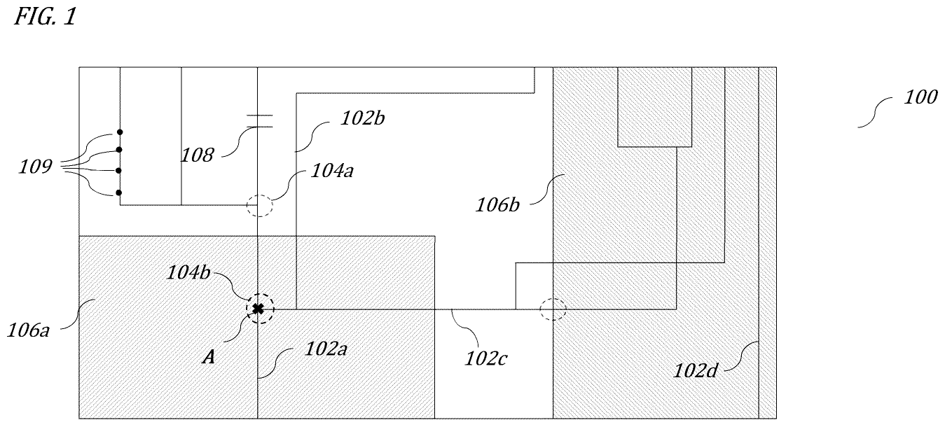

Turning now to FIG. 1, a schematic plan of a conduit network 100 is shown. The network comprises a plurality of conduits 102a, 102b, 102c, 102d. Conduits intersect at junctions 104a and 104b. For clarity, only two junctions and four lengths of conduit are labelled in FIG. 1. However, further junctions and conduit lengths are clearly shown.

A first region 106a is indicated in FIG. 1, through which conduit 102a partially extends. The first region 106a comprises a first identified regional property that applies to the region. An example of an identified regional property may be a soil type, such as clay, soil, sand, etc, or a conduit property, e.g., conduit bore or gauge.

A second region 106b is also indicated in FIG. 1, in which the conduit 102c extends, and which has second regional properties. Another example of a regional property may be a construction material for the conduit network, for example a ballast type.

Although regions 106a and 106b do not overlap in FIG. 1, it will be appreciated that regions having different identified properties may overlap. For example, a length of conduit may extend through a region in which the soil type defines a first property and a construction material defines a second property. In one illustrative example, lengths of conduit may extend through a region in which ballast is laid on clay-type soil.

A structural feature of the conduit network 108 is also shown in FIG. 1. An example of a structural feature may be a tunnel or bridge across or through which a conduit segment runs.

Conduit locations 109 are shown at regular intervals along a section of conduit within the network 100. For simplicity, only four locations are shown, but it will be appreciated that locations may be defined along the conduit throughout the network. Moreover, although the locations are shown evenly spaced in FIG. 1, with constant spacing, it will be appreciated that the locations may not be distributed evenly throughout the network.

Each of the features discussed above may be described as a network context variable which can be associated with a plurality of location in the conduit network. Accordingly, for a plurality of conduit locations (for example, locations 109) a network context variable may be assigned.

For example, and referring still to FIG. 1, at conduit location A two network context variables may be assigned that indicate that (i) the conduit at location A is subject to the first regional properties and (ii) that a junction is present. It will also be appreciated that whilst a location may have one or more network context variables assigned thereto, it is also possible that a location has no network context variables associated with it, or a default network context variable may be assigned, such as “plain conduit”, where no special contextual information is assigned to the location.

The network context variables assigned to each location in a network may be qualitative, for example, for location A, a network context variable may be assigned indicating that the conduit exists on a substrate of Type 1. Alternatively, or additionally, the network context variable for point A may be quantitative, for example, the network context variable may be a value indicating an expected conduit stiffness in the region, or a stiffness of the substrate. In either case, the location A is “labelled” with one or more pieces of information that are relevant to the condition variation (e.g., expected deterioration) of the conduit.

As mentioned above, the network conduit 100 may form part of a transport network such as a railway network or a road network. In such an example, junctions 104a, 104b may comprise intersections or switch points, structural feature 108 may indicate a bridge or tunnel and regions 106a and 106b may indicate regions having different soil types.

The network conduit 100 may alternatively comprise a pipeline network. In such an example, the junctions 104a, 104b may comprise pipeline intersections, the regions 106a, 106b may indicate sub-surface and at-surface locations respectively and the structural feature 108 may indicate a change in pipeline diameter.

It will be appreciated that other conduit networks and other network context variables may be defined.

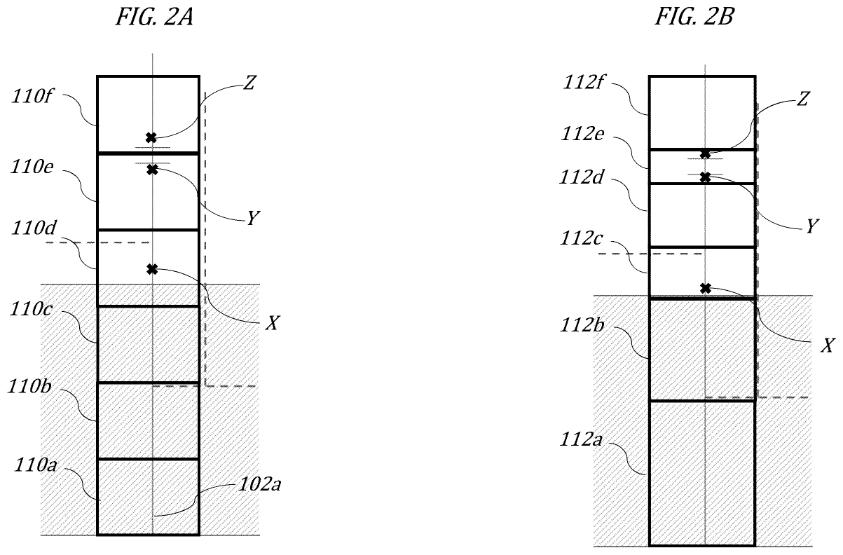

Turning now to FIG. 2A, a sub-region of the conduit network 100 from FIG. 1 is shown. A portion of conduit network comprising conduit 102a is shown. For clarity, conduit 102a is represented by a solid line, with proximate or adjoining conduit portions shown with dashed lines.

As shown in FIG. 2A, the conduit 102a is divided into a plurality of sections, 110a to 110f. The sections 110a to 110f each have equal length and are arranged end to end along the length of the conduit 102a. The fixed-length sections in FIG. 2A illustrate a conventional sectioning technique for monitoring network condition. The condition or performance of each section is usually monitored by measuring a key performance indicator (KPI) indicative of conduit condition and, if the condition of a section falls below a predetermined condition threshold, the section can be identified for maintenance and/or additional monitoring or maintained, upgraded, repaired, or replaced. Examples of KPIs that may be monitored to indicate variation in conduit condition may be conduit geometry (e.g., relative conduit geometry and/or absolute conduit geometry) or another conduit property.

The length of the sections according to a fixed-sectioning approach may be selected based on practical considerations (e.g., a maximum section length may be dictated by data handling constraints) or determined by an industry standard. For example, in the context of European railway networks, a standard section length may be 200 meters, 100 meters or 50 meters (EN13848-6 Annex C). A predetermined condition standard may be, for example, maxima and/or standard deviation values for relative track geometry (RTG) that indicate isolated defects, such as according to EN 13848-1.

One of the disadvantages associated with the conduit sectioning technique shown in FIG. 2A is that the sections are defined independent of the context of the conduit. As a result, although statistical analysis may be carried out to identify sections of conduit that fail to meet one or more predetermined condition standards, the sectioning technique does not allow for differentiation between conduit sections with relatively high maintenance requirements and those with relatively low maintenance requirements. This, in turn, can lead to isolated defects being identified that trigger maintenance and/or monitoring activity across a larger than necessary expanse of the network, as will be explained in more detail below.

Referring still to FIG. 2A, measurement of a key performance indicator representative of conduit condition for the conduit 102a may show that a deviation in conduit geometry that exceeds a predefined threshold value is identified in sections 110d, 110e and 110f such that maintenance is triggered for sections 110d to 110f of conduit. Consider that the thresholds are exceeded for maximum conduit condition variation a result of the measured track geometry at the points X, Y and Z indicated in FIG. 2A. In this example, the high conduit condition variation is caused by a transition between two different environmental conditions at point X, and at either end of the structure 108, as indicated with point Y and Z.

Following the fixed sectioning method illustrated in FIG. 2A, and due to the location of points X, Y and Z within the fixed sections, sections 110d to 110f would be deemed to require maintenance and/or monitoring and the entire length of conduit that extends through sections 110d to 100f would be maintained. Assuming a fixed section length of 200 m, for example, this would result in maintenance of 600 m of track, without isolating the cause of the defect.

In contrast to the fixed-sectioning approach shown in FIG. 2A, the present disclosure provides a dynamic sectioning technique that is based on the context of the conduit in the conduit network. According to embodiments of the disclosure, a conduit network plan is sectioned into a plurality of sections by defining a plurality of conduit lengths for which one or more network context variables for each of a plurality of conduit locations along the respective conduit length meet a predetermined criteria (e.g., a network context criteria). In a simple embodiment, a conduit network may be sectioned into a first section comprising a first length of conduit and a second section comprising a second length of conduit. The network context variables associated with the first conduit length may meet a first criteria, for example, each network context variable for the first length may fall within a first category. The network context variables associated with the second conduit length may meet a second criteria, for example, each network context variable for the second length may fall within a second category. It will be appreciated that third, fourth, fifth, sixth, and nth lengths of conduit may be defined according to methods of the disclosure. An example of dynamic sectioning will now be described in more detail in connection with FIG. 2B.

FIG. 2B shows the same length of conduit 102a shown in FIG. 2A. Like FIG. 2A, the conduit 102a is sectioned into six sections, 112a to 112f. However, rather than the fixed-length sections shown in FIG. 2A, FIG. 2B shows the conduit 102a divided into a plurality of sections of different length. The sections 112a to 112f are defined based on the assigned network context variables for locations along a length of conduit meeting a criteria for the section.

As shown in FIG. 2B, a first section 112a, having first length, covers an unbranched conduit, without junctions, extending through or across the first region 106a having a first identified environmental property. In the illustrated example, the first section 112a is identified because all of the conduit locations in this section have a common assigned network context variable-the regional property associated with region 106a. The locations in section 112a meet a first selection criteria, being associated with region 106a and having no other assigned network context variables.

A second section 112b, having a second length, covers a length of conduit 102a comprising one junction with another conduit, and extending through the first region 106a. Although the plurality of conduit locations associated with section 112b are also assigned a network context variable indicating their location within region 106a, section 112 b additionally comprises a second network context variable, which is the presence of junction 104b. The locations in section 112b therefore meet a second criteria, being associated with region 106a and having one other assigned network context variable, in this case a junction.

A third section 112c, having a third length, includes a transition between the first region 106a and a second region having a second identified property that is different from the first identified property. In other words, the criteria for the third section includes a network context variable indicating a transition between two regions having differing identified properties. Because transitions between regions having differing identified properties are known to impact conduit condition variation, the contextual information for the conduit extending through third section 112c is indicative of higher conduit condition variation than section 110c in FIG. 2A. As such, third section 112c in FIG. 2B is significantly shorter than corresponding section 110c in FIG. 2A.

A fourth section 112d, having a fourth length, covers a length of conduit 102a comprising a length of plain track. A criteria for the fourth section may therefore comprise no assigned network context variables impacting conduit condition for the plurality of locations associated with the section.

A fifth section 112e of conduit, having a fifth length, comprises structure 108. A criteria for the fifth section may therefore be assigned network context variables associated with a structure. Because structures are known to impact relative conduit geometry, the contextual information for the conduit extending through the fifth section 112e is indicative of higher conduit condition variation than section 110e in FIG. 2A. As such, fifth section 112e in FIG. 2B is significantly shorter than corresponding section 110e in FIG. 2A.

A sixth section 112f, having a sixth length, covers a length of conduit 102a comprising a length of plain track. The sixth section 112e in FIG. 2B is approximately the same length as section 110f from FIG. 2A. A criteria for the sixth section may therefore be no associated network variables for the length of conduit within the section (or a default network context variable).

In the event that the same condition measurements for each of a plurality of locations along a length of track are collected for FIG. 2B as FIG. 2A, with peak conduit condition variation measurements collected at points X, Y and Z, according to the sectioning plan shown in FIG. 2B, only sections 112c and 112e exceed the threshold conduit condition value that is a trigger for conduit maintenance. This is not only one section fewer being scheduled for maintenance according to the dynamic sectioning approach from 2B, but the total length of the sections is much shorter than the 600 m that would be scheduled for maintenance according to the fixed sectioning method of FIG. 2A.

In the example above, six illustrative examples for criteria for defining conduit sections have been described. However, it will be appreciated that the present disclosure is not so limited.

In some embodiments, the determination of the sections may be based on a network context variable(s) assigned to conduit locations along a length of conduit being the same. For example, a common qualitative network variable may be assigned to all of the locations associated with a section that passes through a first environmental region and the section may be defined as the length of conduit to which the identified network variable has been assigned. In such an example, the selection criteria for the subset of locations is a common network context variable for all locations within the subset of locations for the section.

In another example, the determination of sections may be based on a network context variable being assigned to conduit locations along the length of conduit such that a minimum proportion of the conduit locations for a section have been assigned the network context variable. For example, a common qualitative network variable may be assigned to a plurality of conduit locations and the first selection criteria may be an 80% threshold for locations being assigned the network context variable being met for a section.

In yet further examples, the determination of sections may be such that plurality of network context variables assigned to locations may be grouped, and the determination of sections may be based on an assigned network context variable for a plurality of locations making up a section length falling within a predefined group. In such an example, the selection criteria may be the plurality of conduit locations being assigned one of a plurality of predefined network context variables.

In yet further examples, one or more network context variables may be assigned a value indicative of conduit condition variation. The determination of sections may then be based on a predicted conduit condition variation associated with identified network context variables falling within a predefined range. The predefined range may be, for example, a predicted maximum conduit displacement distance over a predefined time period t.

In yet further examples, each location may be associated with a plurality of network context variables. In such examples, section length may be determined based on one of the plurality of network context variables or a combination of coexisting network context variables being assigned to the subset of locations associated with the section. Coexisting network variables for a conduit location may be considered independently, combined by simple summation, weighted summation, or compounded (e.g., reflecting the compounding effect coexisting network context variables may have on predicted conduit condition).

In each of the examples set out above, the section lengths may be determined such that the predicted conduit condition variation is homogeneous along a section of conduit, or that the predicted condition variation falls within a target range.

As explained above, the primary section lengths shown in FIG. 2B may be determined based on contextual information for the conduit network. The contextual information may comprise network context variables indicative of conditions that result in increased maintenance requirements compared to base line or reference maintenance requirements, due to higher than usual degradation in track condition.

In one example, referring still to FIG. 2B, contextual information for a plurality of points across a conduit network plan may be recorded. The contextual information may be qualitative (e.g., soil type, conduit material, etc.). Additionally or alternatively the contextual information may comprise quantitative data (e.g., a substrate stiffness estimate or transport velocity through a length of conduit, historical deformation data, etc.).

Each of the conduit context variables may be allocated a value, which is indicative of a predicted conduit condition variation within a predetermined window, for example over a predetermined time interval t. For example, a length of conduit traversing a soft substrate may be expected to degrade more quickly than a length of conduit traversing a firm substrate. Accordingly, a value may be allocated at a plurality of locations along a length of track that indicates that a given context applies to the conduit at a given location. The value may be a unitless value indicating a relative severity of predicted conduit condition variation. Alternatively, the value may represent a predicted measurable conduit condition variation, e.g., relative of absolute conduit geometry.

The plurality of locations may be defined as a relative position within the conduit network. For example, the plurality of locations may be defined by a distance from a predefined start point within the conduit network. Alternatively (or additionally), each location may be defined in terms of an absolute location, for example using location coordinates defined within a global positioning system (GPS). Various systems and methods for determining and identifying conduit network locations will be apparent to the skilled person. For example, location determination using Global Navigation Satellite Systems (GNSS) may be employed to identifying location coordinates for each of the plurality of locations.

To determine a length for each primary section of track, a target range for conduit condition variation may be set, based on a total predicted conduit condition variation associated with the conduit context variables.

The systems and methods disclosed herein include embodiments in which a single network context variable is determined for one or more locations in a network of conduits. In a simple example, a context variable includes determining whether a defined feature or environmental condition is present or not present at a location within the network of conduits and whether or not the variable impacts the predicted condition of the conduit. In such an example, the method may include assigning a yes/no (or 0 and 1) value to the identification of a network context variable that indicates conduit predicted condition variation above a baseline. A value of zero may indicate a standard section length (e.g., identified by an industry standard), whereas a value of greater than zero may indicate a custom section length.

Although the present disclosure encompasses the simple example defined above, additional advantages associated with the dynamic sectioning techniques described herein will generally be realised in systems and methods in which multiple network context variables are defined.

For example, three network context variables may be defined within a conduit network. They may include structures, junctions and identified environmental conditions. Each of the network context variables can be allocated a value indicative of the predicted conduit condition variation associated with that network context variable. The network context variables values may be equal for the defined network context variables or they may be weighted. In any event, embodiments of the disclosure envisage that the three network context variables may be combined to determine a predicted conduit condition variation that reflects the presence of the three network context variables within the network. As described above, sections lengths for monitoring and maintenance within the network may be defined based on a target range for total value for predicted conduit condition variation based on the network context variables.

Some or all of the network context variables may be considered to contribute independently of each other to the total predicted conduit condition variation. Alternatively or additionally, coexisting network context variables may be determined to have a compounding effect on predicted conduit condition. In such cases, the total predicted conduit condition variation may reflect the coexistence of multiple compounding variables.

One of the advantages of determining sections based on contextual information for the network is that maintenance work can be (i) predicted more accurately and (ii) targeted to the areas in which there is need for maintenance work. This may in turn reduce unnecessary and/or inappropriately timed work, which would otherwise cause unnecessary disruption to the normal operation of the network and/or unnecessary resource use.

In one example, a measured KPI for a length of conduit within a conduit network may be relative conduit geometry, wherein a deviation of the conduit from an expected position is measured along the length of the conduit. The conduit condition threshold may be a maximum deviation of the conduit from the expected position. Exceeding the conduit condition threshold may be identified as a trigger to schedule conduit maintenance.

Each network context variable can be associated with a predicted variation in conduit geometry. For example, a soft substrate may be associated with (and predictive of) an average conduit position variation of X, for example, 15 mm, over a time interval t. A junction between two conduit segments may be predictive of an average conduit position variation of Y, for example, 6 mm, over the time interval t. A junction between two conduit lengths in a region of soft substrate may be associated with a predicted conduit position variation based on X and Y.

In the examples set out above, a transition between two regions have differing identified environmental properties can be identified based on the definition of adjacent sections fulfilling different network context variable criteria. For example, in the conduit network shown in FIG. 1, a transition may be defined at the point at which conduit 102a crosses the boundary of region 106a. The assigned network context variables either side of this boundary may be different, resulting in first and second sections being defined either side of a section boundary that corresponds to the transition between regions shown in FIG. 1.

A transition zone may be defined as extending from the boundary in one or both directions. A network context variable representing the presence of a transition zone may be assigned to the plurality of conduit locations falling within the transition zone. Accordingly, a section corresponding to a transition zone may be defined.

In at least some embodiments of the present disclosure, the transition zone may comprise a length of conduit before and/or after the identified transition. The transition zone may be a predefined distance either side of an identified transition. For conduit networks in which there is a directional flow (e.g., a rail or road network or a utility network), the length of the transition zone can be defined downstream of the transition (i.e. in the direction of travel). In at least one example, the length of the transition section can be defined based on an expected or regulated speed or flowrate along the conduit.

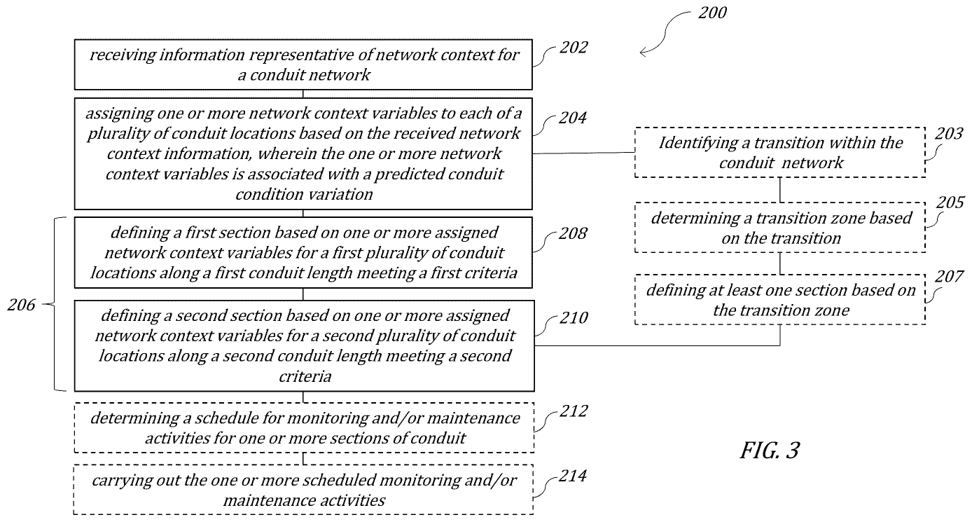

Referring now to FIG. 3, a method according to the disclosure will be described. The method 200 shown schematically in FIG. 3 is a method for sectioning a conduit network for determining maintenance and/or monitoring activities. The method 200 comprises, receiving 202 information representative of network context for a conduit network. The method further comprises assigning 204 one or more network context variables to each of a plurality of conduit locations, wherein the one or more network context variables is associated with a predicted conduit condition variation. The method further comprises sectioning 206 a plan of the conduit network into a plurality of conduit lengths, wherein the sectioning comprises: defining 208 a first section based on one or more assigned network context variables for a first plurality of conduit locations for a first conduit length meeting a first criteria; and defining 210 a second section based on one or more assigned network context variables for a second plurality of conduit locations for second conduit length meeting a second criteria.

The method optionally further comprises: determining 212 a schedule for monitoring and/or maintenance activities for one or more sections of conduit and carrying out 214 the one or more scheduled monitoring and/or maintenance activities according to the schedule.

In some embodiments, the method 200 may further comprise: identifying 203 a transition within the conduit network, defining 205 a transition zone based on the identified transition, and defining 207 at least one section based on the transition zone. For example, a network context variable may be assigned to a plurality of locations along a length of conduit extending through a transition zone. A section may therefore be determined on a network context variable assigned to a plurality of locations along a length of conduit indicating the presence of a transition zone.

The method from FIG. 3 may further comprise defining a third section, a fourth section, a fifth section, and so on, wherein the each section is based on one or more assigned network context variables for a the plurality of conduit locations along the respective conduit length meeting a defined criteria.

Each location of the plurality of locations may be assigned a single network context variable or each location may be assigned multiple network context variables.

The one or more network context variables from FIG. 3 may be qualitative or quantitative. Where multiple network context variables are assigned to one location, they may be qualitative, quantitative or both qualitative and quantitative.

Whether the network context variables are qualitative or quantitative, the criteria for sectioning may be that each of the plurality of locations for a section is assigned the same (or a common) network context variable. Alternatively, context variables may be grouped for the purpose of determining sections. For example, a section may be defined if all (or a threshold proportion) of the assigned network variables for the locations within the section are identified as Type 1, Type 2 or Type 3. Stretches of conduit labelled with network context variable Types 4, 5 or 6 may be allocated to a different section.

A value indicative of predicted conduit condition variation (e.g., degradation) may be assigned to a network context variable. In such examples, a criteria for at least one of the defined sections can be one or more network context variables for each of the conduit locations for the section having a value within a target range, wherein the target range is optionally above or below a threshold value.

In the event that multiple network context variables are assigned to the same location, the threshold value may be a total value for all network context variables for a single location.

Where multiple network context variables are assigned to a location or a plurality of locations, a weighting may be assigned to the network context variables. In some examples, the weighting may reflect the predicted impact of the context on the conduit condition. For example, a substrate with low stiffness may be assigned a relatively high weighting, whereas a connection of Type 1 may be assigned a relatively low weighting since the impact of the substrate on the conduit condition is more strongly correlated with poor conduit condition than a particular type of connection.

The network context variables may also be assigned an order of precedence. In practice, a top-ranked network context variable (expected to have the highest impact on conduit condition of all assigned network context variables) may be assigned a weighting of 1 (if present) and all other assigned variables may be assigned a value of 0.

Coexisting network context variables may also be identified, and in such cases, a value indicative of predicted conduit condition variation may be assigned that is greater than the sum of each independent network context variable. Similarly, mitigative combinations of network context variables may be identified, and a value indicative of predicted conduit condition variation may be assigned that is smaller than the sum of each independent network variable.

As shown in FIG. 3, in any of the embodiments described in connection with this disclosure, a network context variable that may be assigned to a location is whether the location is within an identified transition zone.

A transition zone may be identified on one or both side of a transition between two network contexts within a conduit network. In a simple example, a network may comprise conduit extending across two regions having different substrate types, one stiffer than the other. At the boundary between the two regions having different stiffness, the conduit transitions from a supporting base of relative high stiffness to relatively low stiffness. In other words, a transition may be identified between lengths of conduit having different mechanical properties (such as stiffness) and/or supported by materials having different mechanical properties (such as stiffness). Accordingly, a transition zone can be identified, and “transition zone” may be an assigned network context variable for any of the embodiments described herein.

Taking a road network as an example, as traffic moves from the region of relatively high stiffness to the region of relatively low stiffness, the low stiffness substrate tends to degrade at a higher rate than low stiffness regions remote from the transition. This is because the road surface supported by the softer substrate settles much more quickly than the road surface supported by the stifled substrate, creating a differential settlement problem.

The transition zone may be determined as a distance from the transition (e.g., the boundary between two network contexts). The distance may be determined based on a regulated maximum travel speed for the conduit. For example, a transition zone of ‘2 seconds’ may be defined for a road or rail network. If the maximum regulated speed (e.g., speed limit) for the conduit at the boundary is 100 kmp/h, the transition zone may be defined as extending 28 meters from the boundary. The transition zone may also be defined directionally, based on the regulated direction of travel along the conduit, and/or the nature of the transition. For example, the transition zone may be defined “down-stream” (e.g., in the direction of travel) of a transition from relatively stiff substrate to relatively soft substrate.

In at least some embodiments, transition zones may be defined either side of an identified boundary. In some examples, the transition zone may differ in length in the first and second directions. The difference in length may be determined by the transition between network context variables.

In any of the methods described herein, a pre-sectioning step may be carried out, which comprises: identifying a plurality of structures and/or transition zones within the conduit network, identifying a segment between adjacent identified structures and/or transition zones, and sectioning each of the segments according to the methods described herein.

Examples of network context variables according to the present disclosure include natural environmental conditions, such as water table height, a soil type, etc. Network context variables according to the disclosure also include construction characteristics of the conduit and/or a built environment through which the conduit extends. For example, network context variables include substrate type; a construction characteristic, conduit material(s), geometric parameters of the conduit (e.g., gauge, conduit diameter, etc.) fastener types, connection types, a structure types (e.g., bridges, tunnels, crossings, quays, etc.).

Network context variables may also reflect the volume or nature of the traffic that the conduit network supports. For example, network context variables may include a speed limit or average speed for a length of conduit, an expected tonnage for the conduit, or a flow rate or flow volume of e.g., fluid therethrough.

Network context variables may also reflect historical conduit condition variation data collected the conduit network or a similar conduit network.

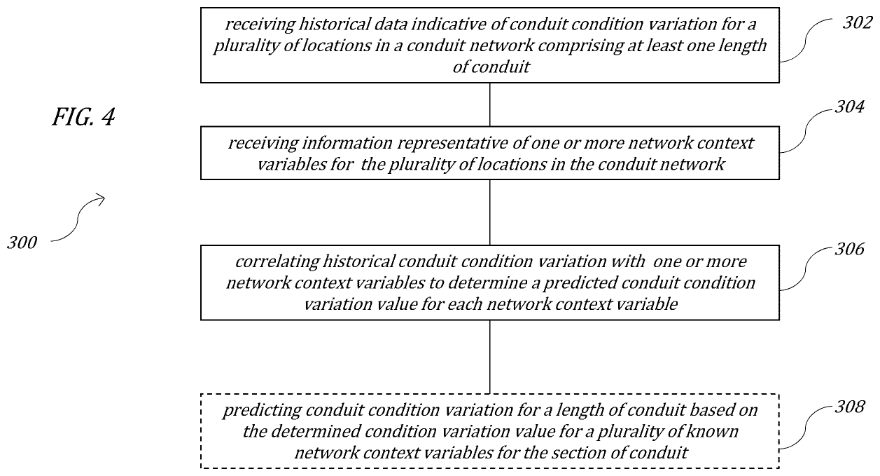

Turning now to FIG. 4, the present disclosure provides a method for predicting conduit condition variation in a conduit network.

As shown in FIG. 4, the method comprises receiving 300 historical data indicative of conduit condition for a plurality of locations in a conduit network comprising at least one length of conduit; receiving 304 information representative of one or more network context variables for some or all of the plurality of locations in the network and correlating 306 the historical conduit condition variation with the network context variables for each location to determine a predicted conduit condition variation value for each network context variable. Optionally, the method may comprise predicting 308 a conduit condition variation for a length of conduit based on the determined condition variation value for a plurality of known network context variables for the section of conduit.

As will be appreciated from the context of the present disclosure, the method of FIG. 4 may be performed independently to determine a predicted conduit variation associated with a plurality of network context variables. This may be done for the purpose of analysis, monitoring, and/or maintenance. Alternatively, the steps of the method shown in FIG. 4 may be carried out in advance of the method of FIG. 3 to determine network context variables for use in the method of FIG. 3 based on historical data.

The historical data indicative of conduit condition can comprise conduit geometry information. The geometry information may be absolute or relative conduit geometry data. Other conduit condition parameters may also be measured to indicate conduit condition variation, for example a change in conduit geometry over time.

As will be appreciated, the method of FIG. 4 may include one or more of the network context variables described above.

The conduit network described above has been presented in general terms and examples of conduit networks to which embodiments of the present disclosure may be applied include railways, pipelines, tunnels, bridges, viaducts, waterways and waterway boundaries, quays, roads, conductive conduit and communications conduit.

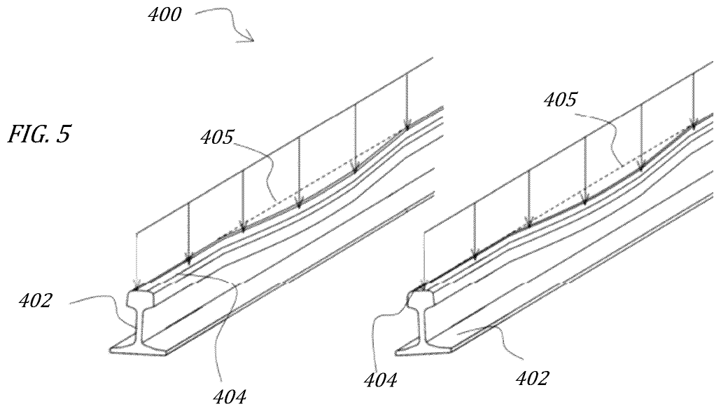

Turning now to FIGS. 5 to 11, an illustrative detailed application of the methods of the disclosure to a railway network will now be described.

In at least some embodiments of the disclosure, the methods described in connection with FIGS. 3 and 4 may be applied in the context of a railway network. In such examples, the conduit network comprises a railway network, the conduit comprises railway track, and, in at least one example, the condition variable associated with the conduit condition is relative track geometry. The network context variables may comprise network context information relevant to the railway track within the network. For example, the network context variables can include track type, substrate type, soil type, structural features such as bridges and/or tunnels, fastener types, types of switches.

FIG. 5 shows a schematic of a section of railway track 400 comprising a pair of parallel rails 402. Each rail comprises a railhead 404, which provides an upper surface along which the wheels of a vehicle run. The track 400 is the conduit as described above. The network context information can be provided for a plurality of locations along the track and be assumed to be the same for the left rail and the right rail. Alternatively, the network context information can be provided for each rail of the track separately.

As shown in FIG. 5, each of the rails 402 of track 400 may suffer a deformation in which the rail 102 is vertically displaced (see arrow A). The dotted line 405 in FIG. 5 shows the location of the upper surface of an ideal, undeformed rail head, known as the ‘zero line’. Vertical deviations from the ideal form for the rail can result in degradation and eventually failure of the track, but may also cause damage and wear and tear to vehicles travelling on the section of track or serious safety incidents, such as derailments. Vertical deviation of the rails may also reduce comfort for passengers. It will be appreciated that the vertical displacement of the rail head 104 shown in FIG. 5 may occur due to uneven settling of the track due to variability in the substrate over which the track runs or due to structural defects, such as broken sleepers.

In addition to the vertical deviation from the zero line illustrated in FIG. 5, railway tracks may suffer horizontal deviation in one or both rails from the ideal position, variable spacing between rails, twisting of one or both rails along the rail longitudinal axis or a combination of all of the above.

To monitor the condition of the railway network and to allow for predictive maintenance before track failures occur, railway networks are inspected on a regular basis to monitor their absolute and relative track geometry. Absolute track geometry represents the ‘as-built’ situation of the track and comprises a series of geospatial coordinates that describes the location of the track within its environment. Relative track geometry represents the longitudinal level, alignment, cant, and twist of the tracks and is used to evaluate track quality.

Absolute and relative track geometry may be collected with a LIDAR (Light Detection and Ranging) scanner mounted on a vehicle that traverses the track for inspection. In general, LiDAR systems allow for the determination of ranges by targeting an object or surface with projected laser radiation and measuring the time it takes for reflected light to be returned to a receiver. LiDAR systems therefore generally comprise an emitter or projector of laser radiation, i.e. a laser source, and a receiver or imaging device configured to detect reflected laser radiation, i.e. a detector.

Accordingly, a LIDAR scanner configured to traverse the section(s) of track for inspection may measure a vertical and/or horizontal position of a rail head. The LiDAR scanner may be configured to collect rail head position data according to a ‘loaded’ regime or an ‘unloaded’ regime. According to European standards (set out in EN13848-1_2019), a loaded measurement in the field of railway monitoring and maintenance is generally understood to mean that the applied loading at the measuring point of the rail shall be equivalent to a minimum vertical wheel load of 25 KN. Outside of this definition of a ‘loaded’ measurement, track geometry measurements and deemed to be ‘unloaded’. Different standards exist around the world and the standards set forth herein are not to be construed as limiting.

It will be appreciated that the measurements taken to indicate track condition are not determinative for the present invention. Rather, any measure used to indicate a condition of the track may be used. Moreover, measurement means besides a LIDAR scanner may be used to measure conduit condition. In at least some examples, a camera may be used to capture information indicative of conduit condition.

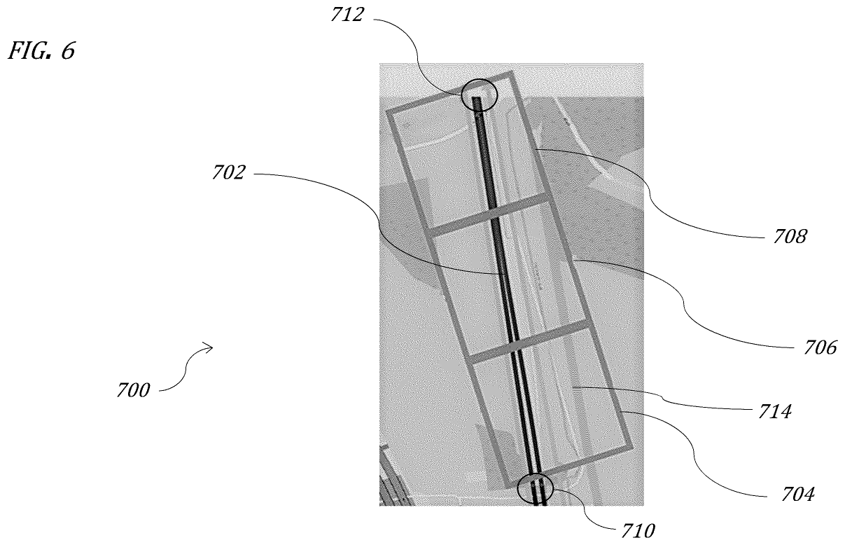

Turning now to FIG. 6, plan for a region 700 of railway network sectioned according to fixed sections lengths are shown. As shown in FIG. 6, the track 702 is sectioned into two 200 m sections 706, 708 (as stipulated in EN EN13848-6). A predetermined condition standard may be, for example, maxima and/or standard deviation values for relative track geometry (RTG) that indicate isolated defects, such as according to EN 13848-1, with a remainder section 702 of 35 m at the top of the figure, as presented. Each of the two 200 m sections, 704 and 706, comprises a south bound track comprising a pair of parallel rails and a northbound track comprising a pair of parallel rails. Section 704 begins immediately north of a steel bridge 710, which is labelled in FIG. 6. Section 704 extends for 200 m in the direction of the track. Section 706 follows section 704 and extends for a further length of 200 m. Section 708 follows section 706 and is the remainder section, having a truncated length of 35 m. A level-crossing 712 is located at the north of the region.

In FIG. 6, some contextual information relating to the location of the track is shown (e.g., the location of a waterway 714) but the section lengths are not influenced by this information. Instead, they begin at a convenient location (e.g., after the steel bridge 710) and continue end to end from that point.

The section of track shown in FIG. 6 was monitored periodically over the period from 2014 to 2022. Specifically, the measured peak values for rail height variation (in mm) were measured by scanning the rail at 25 cm intervals according to EN 13848.

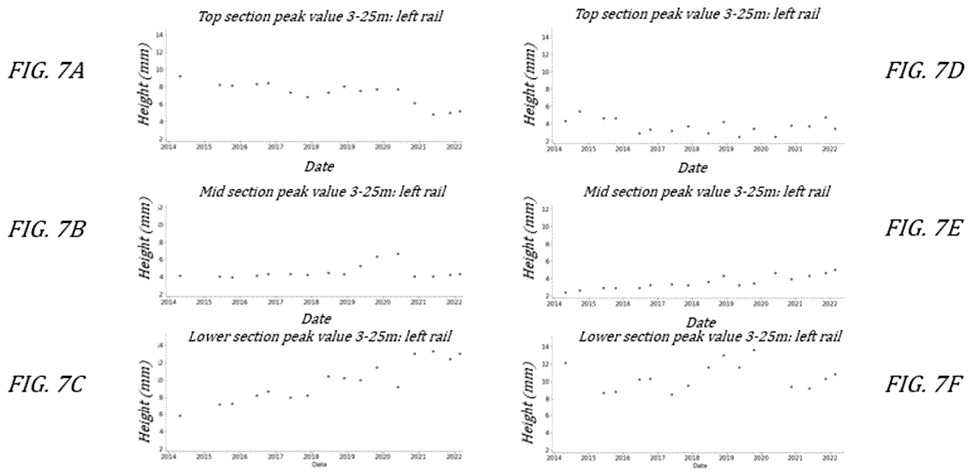

FIGS. 7A to 7F each show the measured peak values for rail height variation (in mm) measured over the period of time starting in 2014 and ending in 2022 for each of the sections shown in FIG. 6. FIGS. 7A to 7C show the peak rail height variation for each section of the southbound track, whilst FIGS. 7D to 7F show the peak variation for each section of the northbound track.

More specifically, FIG. 7A shows rail height for the left rail of the southbound track for section 408, as shown in FIG. 6. As shown in FIG. 7A, the measured rail height for the left track of the southbound track in section 708 shows a generally steady, slightly downward trend over the measured time period. The steady decrease in track height for this section of rail over this period is generally consistent with expected localised deterioration in the track quality due to wear and tear over time, with periodic maintenance work decreasing the track variability peak values over the monitored time period.

FIG. 7B shows rail height for the left rail of the southbound track for section 706 from FIG. 7. FIG. 7B shows a relatively constant peak track height variation for the first 5 years (between 2104 and 2019), an increase in measured peak track height variation between 2019 and 2021, and a return to the base line in 2021 and 2022. The measured peak track height variation for FIG. 7B is consistent with a generally stable section of track, rapid deterioration resulting in maintenance work, and a return to stable operation.

FIG. 7C shows the measured peak rail height variation for the left rail of the southbound track for section 704 from FIG. 7. FIG. 7C shows a sustained and significant increase in measured track height variation over the period between 2014 and 2022. This sustained increase over time is generally consistent with deterioration in track quality over time in a region of track prone to higher track quality variation than average, for example due to a softer than average substrate or support material over which the track extends.

FIGS. 7D to 7F each show the measured peak values for rail height (in mm) measured over a period of time starting in 2014 and ending in 2022 for the northbound track.

FIG. 7D shows rail height for the left rail of the northbound track for section 708, as shown in FIG. 6, and FIG. 7E shows rail height for the left rail of the northbound track for section 706 from FIG. 7. FIG. 7D and FIG. 7E show similar trends to FIGS. 7A and 7B respectively.

FIG. 7F shows the measured rail height for the left rail of the north bound track for section 704 from FIG. 6. FIG. 7F shows highly variable peak track height measurements across the monitored period, indicating poor track quality. From FIG. 7F, it is possible to see that section 704 demonstrates more variation in measured track height than the middle 706 and upper 708 sections, although it is not clear what the cause of the variation is within the section, nor whether a sub-section of section 704 is responsible for the highly variable track quality.

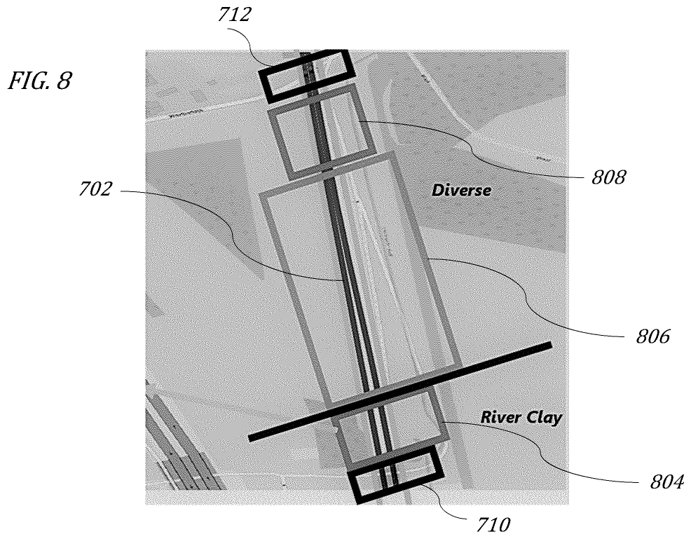

FIG. 8 shows the same section of track as FIG. 6. However, as shown in FIG. 8, network context information is used to determine the length of the sections over which the maximum track height is monitored. The network context information is shown in FIG. 8.

At the north end of the length of track studied (at the top of FIG. 8 as presented), a level crossing is present that intersects both the northbound and the southbound track. The soil type for the northern region of the selected network region is qualitatively identified as “diverse”. The southern end of the length of track in FIG. 8 crosses a steel bridge. North of the steel bridge, in the southern third of the region shown, the soil type is identified qualitatively as “river clay”. The structures (steel bridge and level crossing) shown in FIG. 8 provide network context information, as do the soil type classifications indicated for the different regions in the map.

Each of the pieces of contextual information described above may be considered a network context variable associated with one or more locations along the track within the network. For example, a plurality of locations may be defined at regular intervals along the conduit within the network. For each location, one or more network context variables may be identified that is associated with poor track quality over time (e.g., high track condition variability).

In the network plan shown in FIG. 8, the identified network context variables include: (i) a level crossing; (ii) a steel bridge; (iii) a river clay soil type; and (iv) a diverse soil type. In addition, two transitions are identified: (i) from the level crossing to the ‘regular’ track substrate; and (ii) from the steel bridge to the ‘regular’ track substrate.

The sections in FIG. 8 are selected based on the available network context information. Three sections are identified (as in FIG. 6) but according to the sectioning plan shown in FIG. 8, the middle section (section 806) is longer at 308 m than the equivalent section shown in FIG. 6. The northern section 808 has a length of 72 m and the southern section 804 has a length of 58 m, both shorter than the equivalent sections in FIG. 6.

The lengths of each of the sections shown in FIG. 8 are chosen based on the network context information and primary sections and transition sections are identified. The sections of track are determined based on having network context variables in common, or within a target range, for a plurality of locations. For example, consecutive segments of track traversing regions identified as having “diverse” soil types may form a first section since for each location along a region of track, the network context variable information indicates that a common environmental factor (or factors) apply to the length of track. Transition zones may be identified from the network context variables, and sections may be identified that correspond to the transition zones. For example, in FIG. 8, two transition zones may be identified, one corresponding to section 808, where the track transitions from a level crossing to a regular track environment and another corresponding to section 804, where there is a transition between the steel bridge and the regular track environment.

According to the example shown, for a plurality of locations along the length of conduit extending through the transition zones, the locations are assigned a network context variable “transition zone”. The length of the transition zone may be determined based on e.g., the regulated speed at which traffic may travel along the track. For example, a transition zone equivalent to the distance travelled by a train travelling at the regulated maximum speed for the transition for 5 s, 3 s, 2 s, or 1 s may be defined as the transition zone.

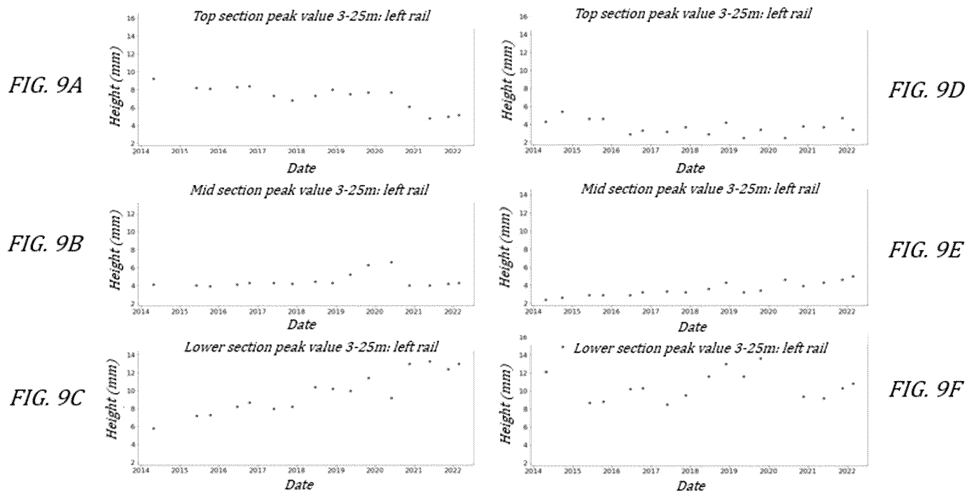

Turning now to FIGS. 9A to 9F, we can see that the high variability in track height associated with section 704 from FIG. 6 is present again in section 804 of FIG. 8 (see FIG. 9F). However, FIG. 9E shows similar variability in track height to FIG. 7E. From this comparison, it is possible to determine that the region of track that has high variation track geometry is the 60 m section 804 shown in FIG. 8.

Although in the example above the measured variable representative of track condition (analogous to conduit condition in the generalised example above) is peak rail height variation over time, it will be appreciated that other variables representative of track condition may be measured. For example, additional or alternative relative track geometries may have been measured, or absolute track geometries may have been measured.

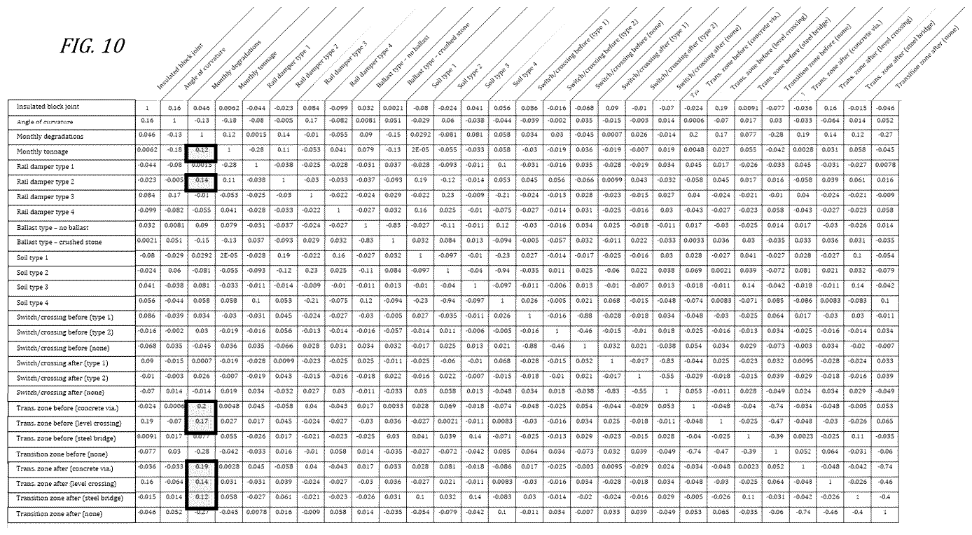

Turning now to FIG. 10, an example of a matrix for the correlation of identified network context variables and track condition is shown. The matrix shows a plurality of known variables for a conduit network, and the correlation between each of the variables. One of the variables shown in FIG. 10 is measured monthly degradations for a location or plurality of locations. Here, the measured monthly degradations are captured by measuring a key performance indicator (KPI) for the conduit network. Examples of KPIs (derived from e.g., conduit geometry measurements) may include height measurements for the track, standard deviations, minima and maxima for track deviations, lateral displacement of the track, root mean square information, kurtosis peak data and others.

Various additional network context variables are shown in FIG. 10. As highlighted in rows 5, 7, 23, 26, 27 and 28 of FIG. 10, the following network variables are highly correlated with the monthly degradation in the track condition shown in row 4 of the table: (i) monthly tonnage passing over the track; (ii) rail damper type 2 used in track construction; (iii) transition zones before and after level crossings; (iv) a transition zones before and after concrete viaducts; (v) transition zones after steel bridges. The information shown in this matrix can be used to identify network context variables that influence track condition and to allocate a value indicative of predicted track deterioration based on the network context variable.

In the example for which a correlation matrix is shown in FIG. 10, a selection of the network context variables (e.g., the presence of transition zones) are indicated in a binary manner, e.g., the presence of a transition zone is assigned a value of “1” and the absence of a transition zone is assigned a value of “0”. When correlated with a measured value (e.g., a numerical value such as measured monthly degradation), medium correlation values are indicative of relevance of the network context variable to conduit condition variation. It will be appreciated that a threshold correlation value may be chosen for determining network context variables of relevance, or the relative importance of a network context variable from a plurality of known network context variables may be used, depending on the network context information available for the network.

The (relative) importance of network context variables can also be determined using a measure of entropy, which can allow the calculation or estimation of network context variable relevance, e.g., as a percentage, in relation to conduit condition variation, such as conduit degradation. In the context of the present disclosure, entropy is a measure of disorder or impurity in a set of examples. In decision trees, entropy may help to determine the best or better attribute(s) for splitting data at each node of the decision tree, with a view to achieving more homogeneous subsets after the split. Entropy ranges from 0 (all examples belong to the same class) to 1 (examples are evenly distributed across classes). A measure of feature importance quantifies how much a feature contributes to decision-making in a decision tree. In the present disclosure, the feature importance can be defined as the influence of a network context variable on conduit condition variation, e.g. conduit degradation. It can be assessed based on the reduction in entropy achieved by using a feature for splitting. Features with the most significant reduction in impurity or entropy are considered more important. That is, they have a more significant impact than other variables on the condition variation of the conduit network. Feature importance helps rank network context variables, identify influential variables, assign weightings to network context variables, and gain further insights into data patterns.

The methods described above with reference to FIGS. 1 to 10 may be implemented by a processing system, for example in the form of a computing device. Accordingly, the methods described herein may form all or part of a computer implemented method, or a system configured to perform the methods described herein.

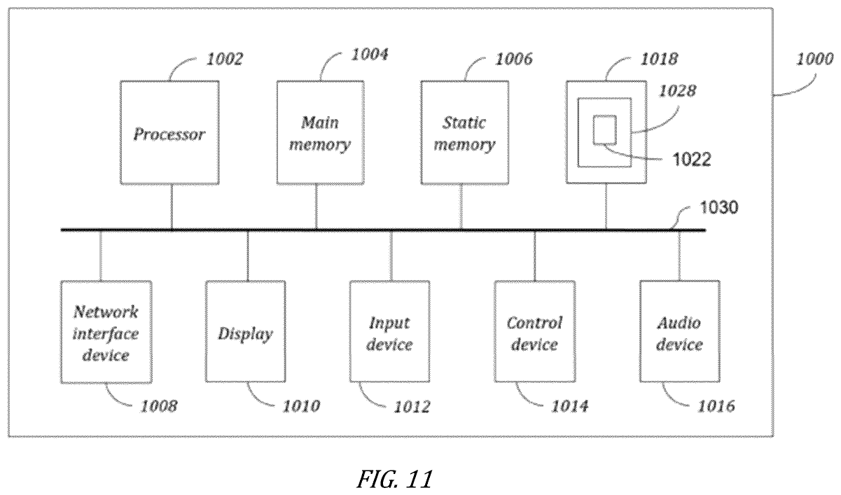

With reference to FIG. 11, a computing device 1000 suitable for carrying out the methods described above will now be described. FIG. 11 shows a block diagram of one implementation of a processing system 1000 in the form of a computing device within which a set of instructions for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example processing system 1000 includes a processor 1002, a main memory 1004 (e.g., read-only memory (ROM), flash memory, dynamic random-access memory (DRAM) such as synchronous DRAM (SDRAM) or Rambus DRAM (RDRAM), etc.), a static memory 1006 (e.g., flash memory, static random-access memory (SRAM), etc.), and a secondary memory (e.g., a data storage device 1018), which communicate with each other via a bus 1030.

Processor 1002 represents one or more general-purpose processors such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processors such as an application specific integrated circuit (ASIC), a field programmable gate array (FPGA), a digital signal processor (DSP), network processor, or the like. Processor 1002 is configured to execute the processing logic (instructions 1022) for performing the operations and steps discussed herein.

The processing system 1000 may further include a network interface device 1008. The processing system 1000 also may include a video display unit 1010 (e.g., a liquid crystal display (LCD) or a cathode ray tube (CRT)), an alphanumeric input device 1012 (e.g., a keyboard or touchscreen), a cursor control device 1014 (e.g., a mouse or touchscreen), and an audio device 1016 (e.g., a speaker).

It will be apparent that some features of the processing system 1000 shown in FIG. 10 may be absent. For example, the processing system 1000 may have no need for display device 1010 (or any associated adapters). This may be the case, for example, for particular server-side computer apparatuses which are used only for their processing capabilities and do not need to display information to users. Similarly, user input device 1012 may not be required. In its simplest form, processing system 1000 comprises processor 1002 and main memory 1004.

The data storage device 1018 may include one or more machine-readable storage media (or more specifically one or more non-transitory computer-readable storage media) 1028 on which is stored one or more sets of instructions 1022 embodying any one or more of the methodologies or functions described herein. The instructions 1022 may also reside, completely or at least partially, within the main memory 1004 and/or within the processor 1002 during execution thereof by the processing system 1000, the main memory 1004 and the processor 1002 also constituting computer-readable storage media 1028.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

The computer program is executable by the processor 1002 to perform functions of the systems and methods described herein. In particular, the computer program is executable by the processor 1002 to receive data collected during a data collection exercise in which a rail position H is measured under first and second load conditions (as described above).

In an implementation, the modules, components, and other features described herein can be implemented as discrete components or integrated in the functionality of hardware components such as ASICS, FPGAS, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,”, “receiving”, “providing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for sectioning a conduit network for monitoring and/or maintenance, the method comprising:
receiving network context information for the conduit network,
assigning one or more network context variables to each of a plurality of conduit locations based on the network context information, wherein the one or more network context variables are associated with a predicted conduit condition variation; and
sectioning a plan of the conduit network into a plurality of conduit lengths, wherein the sectioning comprises:
defining a first section based on the respective one or more assigned network context variables for a first plurality of conduit locations along a first conduit length meeting a first criteria; and
defining a second section based on the respective one or more assigned network context variables for a second plurality of conduit locations along a second conduit length meeting a second criteria.

2. The method of claim 1, wherein sectioning further comprises defining a third section, wherein the third section is based on the respective one or more assigned network context variables for a third plurality of conduit locations along a third conduit length meeting a third criteria.

3. The method of claim 1, wherein the plurality of conduit locations comprises a plurality of locations along a length of the conduit.

4. The method of claim 1, wherein the respective criteria for the respective defined section comprises:
one or more common network context variables being assigned to the plurality of conduit locations for the respective section.

5. The method of claim 1, wherein the respective criteria for the respective defined sections comprises:
a network context variable associated with each of the plurality of conduit locations for the respective section being within a target group.

6. The method of claim 1, wherein the one or more network context variables comprises a value indicative of predicted conduit condition variation.

7. The method of claim 6, wherein the respective criteria for the respective defined sections comprises:
the one or more network context variables for each of the plurality of conduit locations for the respective section having a value within a target range.

8. The method of claim 1, wherein multiple network context variables are assigned to each of the plurality of conduit locations, and wherein the method further comprising assigning a weighting to each network context variable associated with conduit condition variation.

9. The method of claim 1, further comprising:
identifying a transition based on the assigned one or more network context variables; and
defining a transition zone extending in at least one direction from the identified transition.

10. The method of claim 1, wherein the one or more network context variables comprises one or more of:
an environmental condition;
a soil type;
a substrate type;
a construction characteristic;
a connection type;
a structure type;
a conduit material;
a geometric parameter of the conduit;
a speed and/or flow rating for the conduit;
a traffic rating for the conduit;
historical conduit condition variation;
a predicted conduit condition variation; or
a transition zone.

11. The method of claim 1, wherein the conduit network comprises at least one of:
a railway;
a pipeline;
a tunnel;
a bridge;
a viaduct;
a waterway boundary;
a quay;
a road;
a conductive conduit; or
a communications conduit.

12. The method of claim 1, further comprising:
determining a schedule for monitoring and/or maintenance for the respective defined sections of conduit; and
carrying out scheduled monitoring and/or maintenance according to the schedule.

13. A method for predicting conduit condition variation associated with one or more network context variables in a conduit network, the method comprising:
receiving historical conduit condition variation data for a plurality of conduit locations in a conduit network comprising at least one length of conduit;
receiving one or more network context variables for the plurality of conduit locations in the conduit network; and
correlating the historical conduit condition variation data with the one or more network context variables to determine a predicted conduit condition variation value for each network context variable.

14.-15. (canceled).

16. The method of claim 13, wherein the one or more of the network context variables comprises one or more of:
an environmental condition;
a soil type;
a substrate type;
a construction characteristic;
a connection type;
a structure type;
a conduit material;
a geometric parameter of the conduit;
a speed and/or flow rating for the conduit;
a traffic rating for the conduit;
historical conduit condition variation;
a predicted conduit condition variation; or
a transition zone.

17. The method of claim 13, wherein the conduit network comprises at least one of:
a railway;
a pipeline;
a tunnel;
a bridge;
a viaduct;
a waterway boundary;
a quay;
a road;
a conductive conduit; or
a communications conduit.

18. A device for sectioning a conduit network for monitoring and/or maintenance, the device comprising:
a processor; and
a memory storing instructions, which when executed by the processor, cause the device to:
receive network context information for the conduit network,
assign one or more network context variables to each of a plurality of conduit locations based on the network context information, wherein the one or more network context variables are associated with a predicted conduit condition variation; and
section a plan of the conduit network into a plurality of conduit lengths, wherein the sectioning comprises:
define a first section based on the respective one or more assigned network context variables for a first plurality of conduit locations along a first conduit length meeting a first criteria; and
define a second section based on the respective one or more assigned network context variables for a second plurality of conduit locations along a second conduit length meeting a second criteria.

19. The device of claim 18, wherein sectioning further comprises defining a third section, wherein the third section is based on the respective one or more assigned network context variables for a third plurality of conduit locations along a third conduit length meeting a third criteria.

20. The device of claim 18, wherein the plurality of conduit locations comprises a plurality of locations along a length of the conduit.

21. The device of claim 18, wherein the respective criteria for the respective defined section comprises:
one or more common network context variables being assigned to the plurality of conduit locations for the respective section.

22. The device of claim 18, wherein the respective criteria for the respective defined sections comprises:
a network context variable associated with each of the plurality of conduit locations for the respective section being within a target group.
